(19) United States
(12) Patent Application Publication
(10) Pub. No.: US 2021/0067747 A1
(43) Pub. Date: Mar. 4, 2021

(54) Smart Visual Lock System

(71) Applicants: Li Zheng, Kwun Tong (HK); Pin Genie Inc., San Francisco, CA (US)

(72) Inventor: Li Zheng, Kwun Tong (HK)

(73) Assignees: Pin Genie Inc., San Francisco, CA (US); Li Zheng, Kwun Tong (HK)

(21) Appl. No.: 17/005,952

(22) Filed: Aug. 28, 2020

Related U.S. Application Data
(60) Provisional application No. 62/893,885, filed on Aug. 30, 2019.

(51) Int. Cl. H04N 7/18; H04N 5/225; H04N 5/232; G08B 13/08; G07C 9/00; E05B 47/00

(52) U.S. Cl. CPC H04N 7/186; H04N 5/2253; H04N 5/23299; G08B 13/08; E05Y 2900/132; E05B 47/0012; E05Y 2201/434; E05Y 2400/30; E05Y 2400/66; G07C 9/00309

(57) ABSTRACT

The present invention relates to a smart visual lock system. A smart visual lock system, includes a controller, a doorbell, a doorbell button, a WIFI module, a Bluetooth transceiver module, an unlocking relay, a camera, a speaker, a Microphone 111, and mobile terminal, all of which are respectively connected in communication with the controller, wherein the unlocking relay is connected to a lock, the WIFI module communicates with the mobile terminal through a gateway and a router respectively.

### CROSS REFERENCE TO RELATED APPLICATIONS

This patent application claims the benefit of U.S. Prov. Ser. No. 62/893,885 filed Aug. 30, 2019, the disclosure of which is hereby incorporated herein by reference.

### FIELD OF THE INVENTION

The present invention relates to a smart visual lock system.

### BACKGROUND OF THE INVENTION

Doorbells can enable a person located outside of an entry point, such as a door, to alert a person inside of an entry point that someone outside would like to talk to someone inside or want to get into the door. Doorbells sometimes include a button located near a door, such as a front door, side door, or back door of a home, office, dwelling, warehouse, building, or structure. Doorbells are sometimes used near a gate or some other entrance to a partially enclosed area. Pushing the doorbell sometimes causes a chime or other alerting sound to be emitted.

When a visitor presses a doorbell button from outside the door, the controller communicatively coupled to the doorbell button receives a trigger signal from the doorbell button, and then the controller controls the doorbell (e.g., indoors and/or integrated on the lock), and the doorbell sounds to alert the user.

In a prior art doorbell system, when a user located outdoors presses the doorbell system, there must be someone indoors who can unlock the user located outdoors. In other words, if there is no one indoors, the outdoor user cannot remind the indoor user to unlock through the doorbell system.

In addition, in the prior art doorbell system described above, usually a display is installed in a fixed position indoors, such as a wall near the doorway, and communicates with a camera of the doorbell system to display images of an outdoor user in real time. The indoor user must use this display to see the real-time images of the outdoor user. If the owner is not at home, he cannot see real-time images outside the door or images of users outside the door in real time.

Therefore, it is necessary to provide an improved doorbell system, such as a smart visual lock system provided by the present invention, so that even if the owner is not at home, he can use, for example, his mobile terminal such as a mobile phone to see the image of the user outside the door in real time. After the owner's mobile terminal receives the unlocking reminder from the user outside the door, the lock is unlocked through the remote wireless method.

### SUMMARY OF THE INVENTION

The present invention provides a smart visual lock system. With the smart visual lock system provided by the present invention, even if the owner is not at home, he can still use, for example, his mobile terminal such as a mobile phone to see the image of the user outside the door in real time. Moreover, after the owner's mobile terminal receives the unlocking reminder from the user outside the door, the lock is unlocked through the remote wireless method.

In order to achieve the above object, the present invention adopts the following technical solution.

A smart visual lock system, includes:

a controller, a doorbell, a doorbell button, a WIFI module, a Bluetooth transceiver module, an unlocking relay, a camera, a speaker, a Microphone, and mobile terminal, all of which are respectively connected in communication with the controller, wherein the unlocking relay is connected to a lock, the WIFI module communicates with the mobile terminal through a gateway 115 and a router respectively.

Additional aspects and advantages of the invention will be set forth in part in the description which follows.

### BRIEF DESCRIPTION OF THE DRAWINGS

In order to more clearly illustrate the technical solution in the embodiments of the present invention, the drawings used in the embodiments or the prior art description will be briefly described below. Obviously, the drawings in the following description are only some embodiments of the present invention, but the invention is not limited thereto.

FIG. 1 is a schematic structural view of a smart visual lock system according to an embodiment of the present invention;

FIG. 2 is an exploded view of a lock according to an embodiment of the invention;

FIG. 2A is another view of a lock according to an embodiment of the invention;

FIG. 3 is a cross-sectional view of a lock according to an embodiment of the invention;

FIG. 4 is a working schematic diagram of the lock according to the embodiment of the invention in a normal state;

FIG. 5 is a working schematic diagram of the lock triggering the detection switch according to the embodiment of the invention;

FIG. 6 is another view of a lock according to an embodiment of the invention; and

FIG. 7 is another view of a lock according to an embodiment of the invention;

### DETAILED DESCRIPTION OF THE INVENTION

The invention is further described in the following with reference to the drawings and exemplary embodiments, which are illustrated in the accompanying drawings, in which the same or similar reference numerals are used to refer to the same or similar elements or elements having the same or similar functions. The embodiments described below with reference to the drawings are intended to be illustrative of the invention and are not to be construed as limiting. Further, if a detailed description of a known technique is not necessary to show the features of the present invention, it will be omitted.

Specific embodiments of the invention are described in detail below.

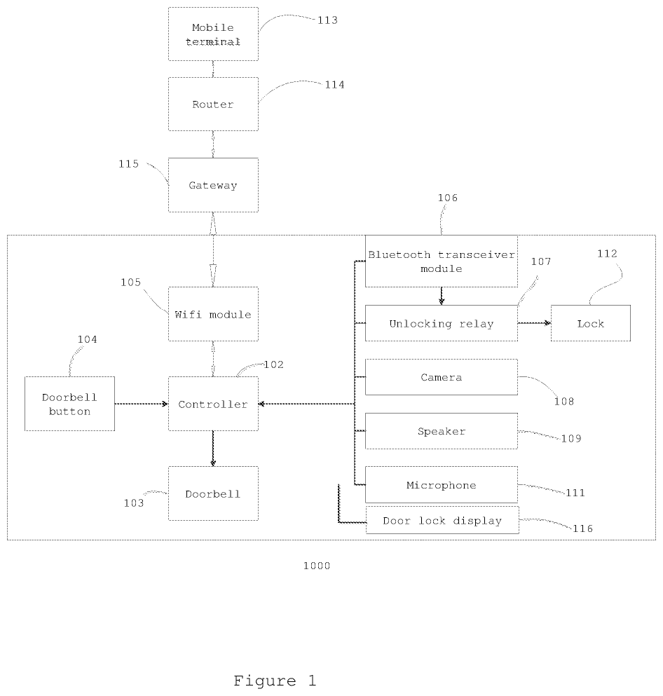

Please refer to FIG. 1. According to one embodiment of the present invention, there is provided a smart visual lock system 1000. The smart visual lock system 1000 includes a controller 102, a doorbell 103, a doorbell button 104, a WIFI module 105, a Bluetooth transceiver module 106, an unlocking relay 107, a camera 108, a speaker 109, a Microphone 111, and mobile terminal 113, all of which are respectively connected in communication with the controller 102. Here, the unlocking relay 107 is connected to a lock 112. In addition, the WIFI module 105 communicates with the mobile terminal 113 through a gateway 115 and a router 114 respectively.

When a visitor presses the doorbell button 104 from outside a door, the controller 102 communicatively coupled to the doorbell button 104 receives a trigger signal therefrom, and then the controller 102 controls the doorbell 103 (eg, indoors and/or integrated on the lock 112), and the doorbell 103 sounds to alert the user.

The camera 108 that communicates with the controller 102 is set to maintain a power save mode when no visitor presses the doorbell button 104. In this way, when the visitor presses the doorbell button 104 from outside the door, the controller 102 receives a trigger signal from the doorbell button 104, and then drives the camera 108 to enter a working mode from a power saving mode, so that real-time images and videos of the surrounding environment can be collected. The controller 102 obtains the video captured by the camera 108, and then transmits the real-time image and/or video through the WIFI module 105 that communicates with the controller 102 and a gateway 115 that wirelessly communicates with the WIFI module 105 and a router 114 that wirelessly communicates with the gateway to the user's mobile terminal 113 such as a mobile phone. In this way, when a visitor visits, the user can use his mobile phone to know who is visiting. In addition, it is not only when a visitor presses the doorbell button 104 that the user's mobile phone receives live images and videos, but also, the user can actively view the images captured by the camera 108 in real time by operating related software on the mobile phone of the user.

After the user sees the visitor's image through the mobile phone, the related software on the mobile phone can be operated, so that the unlocking command is transmitted to the controller 102 through the router 114, the gateway 115 and the WIFI module 105. After the controller 102 receives the above-mentioned user's unlocking command, it drives the unlocking relay 107 to generate a certain action, which causes the lock 112 to be opened, so that the visitor can open the door and enter the room. Optionally, the user's unlocking command can also be transmitted to the controller 102 by the router 114, the gateway 115, and the Bluetooth transceiver module 106. The controller 102 then drives the unlocking relay 107 to produce a certain action that causes the lock 112 to be opened.

When the visitor presses the doorbell button 104, the controller 102 starts the work of the speaker 109 and the microphone 111 after receiving a trigger signal from the doorbell button 104. In this way, the visitor can transmit his own voice to the controller 102 through the microphone 111, and then the controller 102 transmits a sound signal to the user's mobile phone by means of the above WIFI module 105 or Bluetooth transceiver module 106 and the gateway 115 and router 114. The user can hear the visitor's voice through a speaker built in his mobile phone. At the same time, the user can use a microphone on the mobile phone to transmit his voice through the controller 102, the gateway 115, router 114, WIFI module 105 or Bluetooth transceiver module 106 to the speaker 109 communicated with the controller 102. Thus, the visitor can hear the user's voice, thereby realizing real-time voice communication between the visitor and the user.

In addition, the smart visual lock system 1000 of the present invention can also realize the function of smart remote opening of the lock 112 by the user directly by means of his own mobile phone, regardless of the visitor. For example, when other authorized person of the user needs to enter the room but has no key with him, and when the authorized person walks to the door, the user can operate his mobile phone to realize the function of unlocking the door for the authorized person. The principle and operation flow are as described above. In other words, the user can operate the relevant software on the mobile phone, so that a unlocking command is transmitted to the controller 102 through the router 114, the gateway 115 and the WIFI module 105. After the controller 102 receives the unlocking command of the user, it drives the unlocking relay 107 to generate a certain action, thereby causing the lock 112 to be opened. Alternatively, the user's unlocking command can also be transmitted to the controller 102 via the router 114, gateway 115, and Bluetooth transceiver module 106. Then the controller 102 drives the unlocking relay 107 to generate a certain action, which causes the lock 112 to be opened. Therefore, the authorized person without the key can enter the room through the remote smart unlocking of the user.

The smart video doorbell lock system 1000 may also include a door lock display 116 integrated into the lock 112. This makes it easy to input the unlock password or set the unlock password by means of the door lock display 116.

Preferably, the gateway 115 communicates with the router 114 through the RJ45 communication protocol. Moreover, it is preferable that 2.4 G telecommunication protocol is used between the WIFI module 105 and gateway 115, so that it is possible to transmit large video data from the camera 108 to the mobile terminal 113 at a high speed.

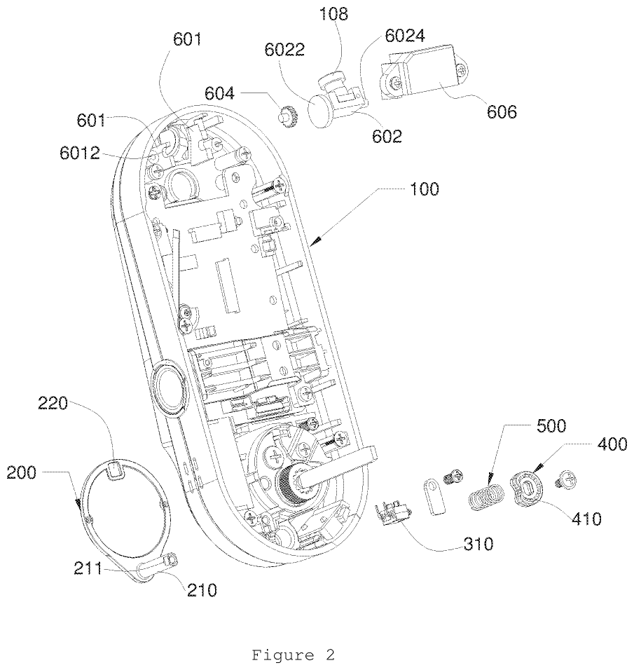

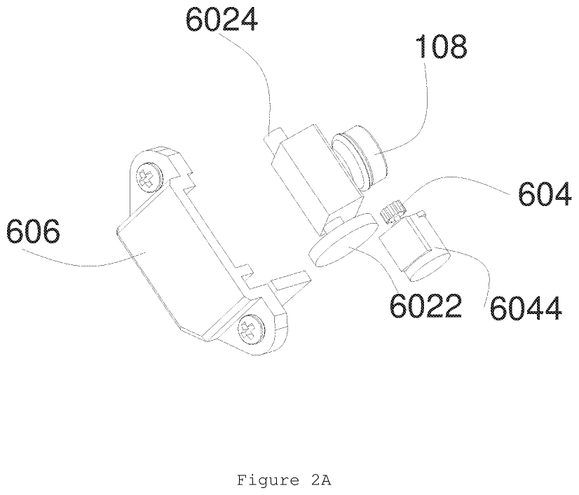

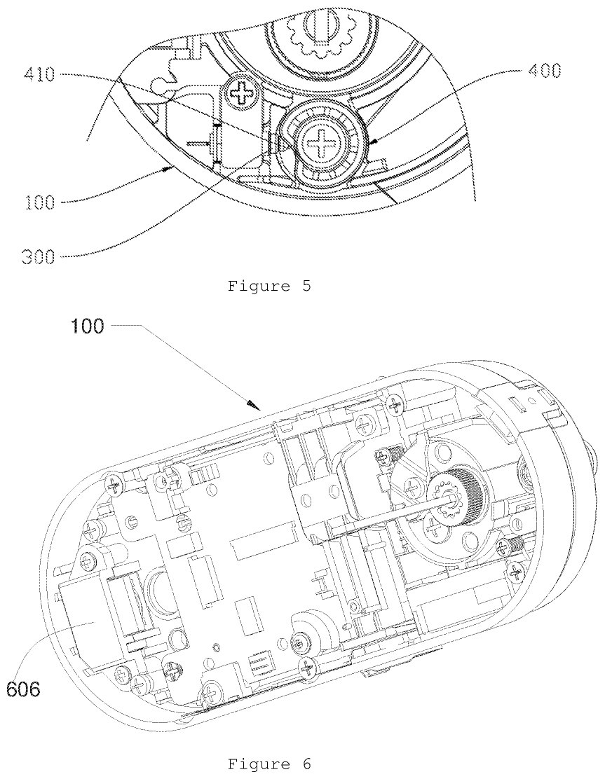

Preferably, the lock 12 of the smart visual lock system of the embodiment of the invention may take different physical forms. FIGS. 2-5 show detailed structure of the lock 112.

As shown in FIGS. 2-5, the lock 112 includes a locking device 100, a cover plate 200, a detection unit, and a lock control unit. The locking device 100 is provided with a lock hole for unlocking, and the user can mechanically unlock the locking device 100 through the lock hole. The cover 200 is arranged on the outside of the locking device 100 and covers the lock hole. When the user wants to use a mechanical key to unlock the locking device 100, he must first rotate the cover 200 to expose the lock hole, and then the locking device 100 performs mechanical unlocking. The detection unit is arranged inside the locking device 100 for detecting whether the cover 200 is rotated and sending this information to the lock control unit when the cover 200 is rotated.

The lock control unit is arranged inside the locking device 100, and the lock control unit includes a circuit board and a transmitter. When the detection unit detects that the cover 200 is rotated and feeds it back to the lock control unit, the circuit board in the lock control unit will control the transmitter through a preset program to send this message to the user's mobile phone to remind the user that the cover 200 has been opened illegally.

According to the embodiment of the invention, the safety of the lock is enhanced. Specifically, when the lock is equipped with a fingerprint lock or a code lock, it is generally equipped with a mechanical keyhole. When the user's fingerprint is damaged or the password is forgotten, the lock can be unlocked by mechanical unlocking. However, in the traditional mechanical unlocking method, as long as the key matches the shape of the lock hole, the locking device 100 can be unlocked. When the key is illegally stolen by a person, he can use the key to directly unlock the locking device 100.

In the present invention, the cover 200 is provided on the mechanical lock hole, and the detection unit for detecting whether the cover 200 is rotated and the lock control unit for sending a signal are provided inside the locking device 100. When someone rotates the cover 200 to unlock the locking device 100 by mechanical unlocking, the detection unit will detect the rotation of the cover 200. The detection unit will send the information that the “cover 200” has been moved to the circuit board of the lock control unit, and the circuit board of the lock control unit will send this signal to the user's mobile phone through a transmitter, so that the user can get to know that the locking device 100 is illegally.

In some specific embodiments of the invention, the detection unit includes a detection switch 310. The detection switch 310 is provided inside the locking device 100. The detection switch 310 is provided with a compression spring. When the cover 200 rotates and contacts the detection switch 310 provided in the locking device 100, the compression spring is compressed. The detection switch 310 is in a triggered state. At this time, the detection switch 310 will send a signal “cover 200 is opened” to the lock control unit.

When the cover 200 is reset, the cover 200 is no longer in contact with the detection switch 310, the compression spring will lift the detection switch 310, and the detection switch 310 is released from the triggered state. At this time, the detection switch 310 does not send a signal “the cover 200 is opened” to the lock control unit.

In a further embodiment of the invention, a cover shaft 210 extending into the locking device 100 is provided on the cover 200, and a cam 400 is provided on the cover shaft 210, and the cam 400 is used to trigger the detection switch 310. The cover shaft 210 is eccentrically arranged on the cover 200, and the cover shaft 210 extends into the locking device 100 and is connected to the cam 400 provided inside the locking device 100. The cam 400 and the detection switch 310 are arranged at the same height and used to trigger the detection switch 310. Specifically, when the user wants to open the cover 200 and use a mechanical lock hole to unlock, he first rotates the cover 200 around the cover shaft 210 to expose the lock hole. During the rotation of the cover shaft 210, the cam 400 provided at one end of the cover shaft 210 is driven to rotate together. When the cam 400 rotates, it touches the detection switch 310, and then the detection unit detects that the cover 200 is moved.

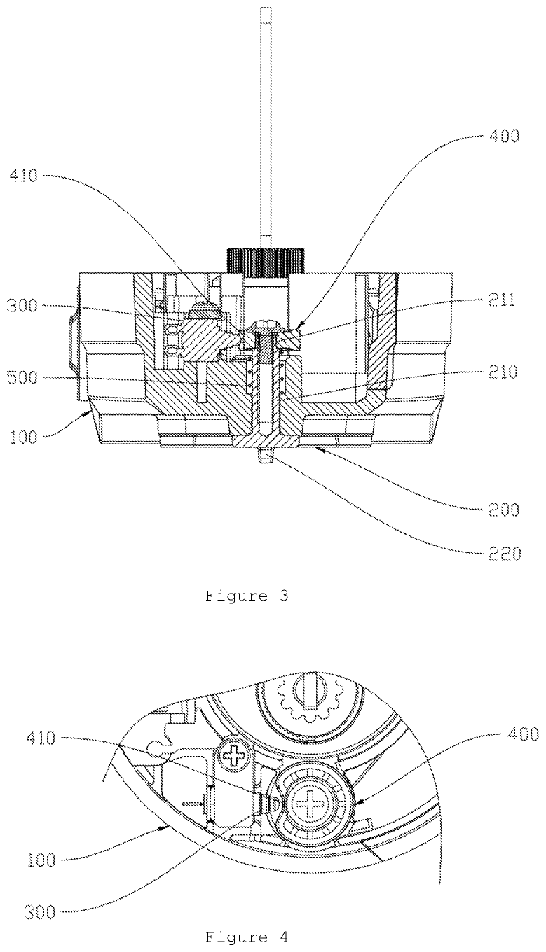

As shown in FIGS. 2 and 3, one end of the cover shaft 210 is provided with a notch 211, and a mounting hole of the cam 400 matches the shape of the end of the cover shaft 210. The cam 400 and the cover shaft 210 are connected by a screw. The cam 400 is fixed on the notch 211 after being installed on the cover shaft 210 and is located at the same height as the detection switch 310. By arranging a matching mounting part between the cover shaft 210 and the cam 400, it can be ensured that the cam 400 and the detection switch 310 are always at the same height. When the cam 400 rotates together with the cover shaft 210, the detection switch 310 is triggered. Since the mounting hole of the cam 400 matches the shape of the notch 211 on the cover shaft 210, when the cam 400 is fixed on the cover shaft 210, there will be no relative rotation between the cam 400 and the cover shaft 210. This effectively prevents the cam 400 from accidentally touching the detection switch 310, and avoids sending a signal to the user when the cover 200 is not moved.

In a further embodiment of the invention, a groove 410 is provided on the cam 400, and the position of the detection switch 310 corresponds to the position of the groove 410. The detection switch 310 is arranged inside the locking device 100 and its position corresponds to the groove 410. When the cover 200 is stationary and covers the key hole, the detection switch 310 is facing the groove 410. When the cover 200 is rotated, the cam 400 will rotate accordingly. During the rotation, the side wall of the groove 410 will squeeze the detection switch 310. After the detection switch 310 is squeezed, the detection unit will detect that the cover 200 is moved. The detection switch 310 is arranged at a position corresponding to the groove 410, and will not block the rotation of the cam 400. When the detection switch 310 is in contact with the inner wall of the groove 410, it will retract. After the groove 410 rotates with the cam 400 to leave the position corresponding to the detection switch 310, the detection switch 310 will contact the outer wall of the cam 400. The outer wall of the cam 400 continues to press the detection switch 310 to allow the detection unit to detect that the cover 200 is moved. Only when the cover 200 is rotated back to the original position, the groove 410 is aligned with the detection switch 310 again, the detection switch 310 is no longer compressed, and the detection unit cannot detect that the cover 200 is moved, the lock control unit will stop sending to the user warning.

In a further embodiment of the invention, a spring 500 is provided on the cover shaft 210, and the spring 500 is provided between the locking device 100 and the cam 400. The spring 500 is sleeved on the cover shaft 210, both ends of the spring 500 are in contact with the cam 400 and the locking device 100, and the spring 500 is in a compressed state. The spring 500 in the compressed state allows the cam 400 and the locking device 100 to move away from each other. Under the action of this trend, the cover plate 200 fixedly connected to the cam 400 is tightly attached to the locking device 100, and will not spontaneously rotate due to the weight of the cover plate 200 and other factors, causing the cam 400 to contact the detection switch 310.

In some specific embodiments of the invention, the camera 108 is electrically connected to the lock control unit. When the detection unit detects that the cover 200 is moved, the camera 108 will take a photo of the person turning the cover 200 and record it, and send it to the user's mobile phone through the lock control unit. After receiving the photo information, the user can know whether the lock has been illegally opened by illegal persons.

In some specific embodiments of the invention, an alarm device is further included, and the alarm device is electrically connected to the lock control unit. By setting the alarm device, when the detection unit detects that the cover 200 is moved, the lock control unit will control the alarm device to emit an alarm sound to warn someone who illegally open the locking device 100. When the user wants to unlock the lock mechanically and normally, he can first set the lock in the mobile phone to not alarm, and then rotate the cover 200 to expose the lock hole to mechanically unlock the lock.

In some specific embodiments of the invention, a rectangular protrusion 220 is provided on the outer surface of the cover 200, and there is a certain distance between the protrusion 220 and the cover shaft 210. By providing the protrusion 220 on the outer surface of the cover plate 200, the user can directly apply force to the protrusion 220 when rotating the cover plate 200 to achieve the purpose of rotating the cover plate 200.

When the cover 200 is covered on the lock hole, the detection switch 310 corresponds to the position of the groove 410 on the cam 400, and there is enough space on the groove 410 to accommodate the detection switch 310. When the user accidentally touches the cover 200 by mistake, and causes the cam 400 to rotate slightly, the detection switch 310 will not be triggered at all. When another person wants to open the lock cover to unlock the lock by mechanical unlocking, during the process of turning the cover 200, the cam 400 will rotate together with the cover shaft 210, and then squeeze the detection switch 310. After the detection switch 310 is compressed, the detection unit detects that the cover 200 is moved, and then controls the camera 108 to take pictures of others, and sends the pictures information to the user's mobile phone. At the same time, the alarm device will sound an alarm to warn others.

When the user wants to unlock the lock through mechanical unlocking, he can first send an instruction to the lock control unit through the mobile phone to turn off the alarm device or camera and other functions. When the user turns the cover 200 and the cam 400 is in contact with the detection switch 310, the detection unit will not feedback the information “the cover 200 is moved” to the user through the lock control unit. The user can unscrew the cover 200 to mechanically unlock the lock without obstruction. After the user unlocks the lock, he can issue instructions to the control unit again through the mobile phone to restore the alarm device or camera, etc., and continue to detect whether anyone wants to open the lock by mechanical unlocking.

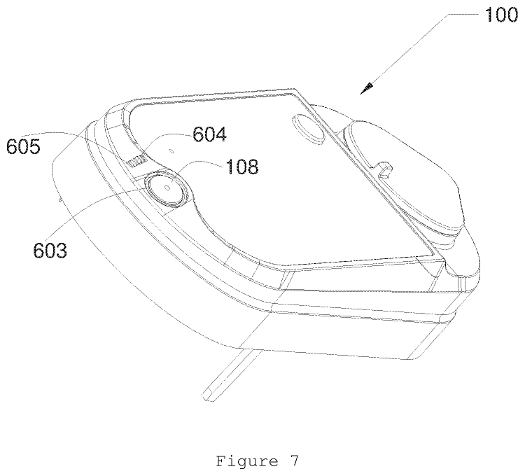

Please further refer to FIGS. 2, 2A and 6-7, according to another embodiment of the invention, the lock 112 includes a locking device 100, and the camera 108 of the smart visual lock system 1000 can be installed on the locking device 100 in a manner that the angle can be adjusted. Specifically, the camera 108 is mounted on the locking device 100 by means of a camera angle adjustment device.

The camera angle adjustment device includes:

a camera mounting frame 602 provided with a driven gear 6022 on one lateral side thereof and a rotating shaft 6024 on the other lateral side thereof;

a pair of support walls 601 spaced apart from each other and provided on the locking device 100, a recess 6012 being formed on a top of each support wall 601;

a drive gear 604 meshed with the driven gear 6022; and

a mounting cover 606 secured on the camera mounting frame 602, thereby fixing the camera mounting frame 602 on the locking device 100. A first window 603 and a second window 605 are opened on one surface of the locking device 100. The driving gear 604 is exposed from the second window 605, and the camera 108 is exposed from the first window 603.

The camera 108 is mounted on the camera mounting frame 602. The camera mounting frame 602 is arranged between the pair of supporting walls 601, and the rotating shaft 6024 and the driven gear 6022 of the camera mounting frame 602 are respectively supported in the corresponding recesses 6012.

The user can manually move the driving gear 604 exposed from the second window 605 to rotate the driving gear 604, and then drive the driven gear 6022 to rotate in the opposite direction, thereby causing rotation of the camera mounting frame 602, which eventually causes the angle of the camera 108 to be adjusted within a certain range.

Preferably, referring to FIG. 2A, the drive gear 604 is connected to a motor 6044, so that the motor 6044 provides rotational power to the drive gear 604, and in turn, the user does not need to dial the drive gear 604 by hand, he just needs to use his own mobile terminal to control the motor 6044 thereby causing the motor to run, so as to realize the angle adjustment of the camera.

The present invention adds a camera angle adjustment device to the locking device of the smart visual lock system, so that users can adjust the shooting angle of the camera to meet the use requirements of different users.

The user can check the recording effect of the camera 108 by means of, for example, the above-mentioned mobile terminal 113. When the user feels that the position of the viewing angle is not the desired effect, the user can adjust the angle of the camera 108 in the above-mentioned manner.

While some exemplary embodiments of the invention have been shown in the foregoing, however, it will be understood by those skilled in the art that the present invention may be modified without departing from the spirit and scope of the invention. The scope of the invention is defined by the claims and their equivalents.

1. A smart visual lock system, comprising:
a controller, a doorbell, a doorbell button, a WIFI module, a Bluetooth transceiver module, an unlocking relay, a camera, a speaker, a Microphone, and mobile terminal, all of which are respectively connected in communication with the controller, wherein the unlocking relay is connected to a lock, the WIFI module communicates with the mobile terminal through a gateway and a router respectively.

2. The smart visual lock system as recited in claim 1, wherein the gateway communicates with the router through the RJ45 communication protocol.

3. The smart visual lock system as recited in claim 2, wherein a 2.4 G telecommunication protocol is used between the WIFI module and gateway.

4. The smart visual lock system as recited in claim 3, wherein the lock includes:
a locking device provided with a lock hole;
a cover plate arranged outside the locking device, and used to cover the lock hole; and
a detection unit used to detect whether the cover plate rotates;
the lock control unit is electrically connected with the detection unit.

5. The smart visual lock system as recited in claim 4, wherein the detection unit includes a detection switch.

6. The smart visual lock system as recited in claim 5, wherein the cover plate is provided with a cover plate shaft extending into the locking device, and the cover plate shaft is provided with a cam, and the cam is used for triggering the detection switch.

7. The smart visual lock system as recited in claim 6, wherein the cam is provided with a groove, and the position of the detection switch corresponds to the position of the groove.

8. The smart visual lock system as recited in claim 6, wherein a spring is arranged on the cover shaft, and the spring is arranged between the lock and the cam.

9. The smart visual lock system as recited in claim 8, wherein the camera is electrically connected with the lock control unit.

10. The smart visual lock system as recited in claim 9, further comprising an alarm device electrically connected with the lock control unit.

11. The smart visual lock system as recited in claim 10, wherein a protrusion is provided on an outer surface of the cover plate.

12. The smart visual lock system as recited in claim 11, wherein the camera is mounted on the locking device by means of a camera angle adjustment device.

13. The smart visual lock system as recited in claim 12, wherein the camera angle adjustment device comprises:
a camera mounting frame provided with a driven gear on one lateral side thereof and a rotating shaft on the other lateral side thereof;
a pair of support walls spaced apart from each other and provided on the locking device, a recess being formed on a top of each support wall;
a drive gear meshed with the driven gear; and
a mounting cover secured on the camera mounting frame, thereby fixing the camera mounting frame on the locking device;
a first window and a second window are opened on one surface of the locking device;
the driving gear is exposed from the second window, and the camera is exposed from the first window;
the camera is mounted on the camera mounting frame; the camera mounting frame is arranged between the pair of supporting walls, and the rotating shaft and the driven gear of the camera mounting frame are respectively supported in the corresponding recesses.

14. The smart visual lock system as recited in claim 13, wherein the drive gear is connected to a motor.

15. The smart visual lock system as recited in claim 3, wherein the lock includes:
a locking device; and the camera is mounted on the locking device by means of a camera angle adjustment device.

16. The smart visual lock system as recited in claim 15, wherein the camera angle adjustment device comprises:
a camera mounting frame provided with a driven gear on one lateral side thereof and a rotating shaft on the other lateral side thereof;
a pair of support walls spaced apart from each other and provided on the locking device, a recess being formed on a top of each support wall;
a drive gear meshed with the driven gear; and
a mounting cover secured on the camera mounting frame, thereby fixing the camera mounting frame on the locking device;
a first window and a second window are opened on one surface of the locking device;
the driving gear is exposed from the second window, and the camera is exposed from the first window;
the camera is mounted on the camera mounting frame; the camera mounting frame is arranged between the pair of supporting walls, and the rotating shaft and the driven gear of the camera mounting frame are respectively supported in the corresponding recesses.

17. The smart visual lock system as recited in claim 15, wherein the camera angle adjustment device comprises:
a camera mounting frame provided with a driven gear on one lateral side thereof and a rotating shaft on the other lateral side thereof;
a pair of support walls spaced apart from each other and provided on the locking device, a recess being formed on a top of each support wall;
a drive gear connected to a motor and meshed with the driven gear; and
a mounting cover secured on the camera mounting frame, thereby fixing the camera mounting frame on the locking device;
a first window is opened on one surface of the locking device;
the camera is exposed from the first window;
the camera is mounted on the camera mounting frame; the camera mounting frame is arranged between the pair of supporting walls, and the rotating shaft and the driven gear of the camera mounting frame are respectively supported in the corresponding recesses.
